(19) United States
(12) Patent Application Publication
(10) Pub. No.: US 2019/0075968 A1
(43) Pub. Date: Mar. 14, 2019

(54) MODULAR FIREBOX FOR COOKING GRILL

(71) Applicant: OOKI, LLC, Montezuma, KS (US)

(72) Inventor: VINCENT G. KOEHN, MONTEZUMA, KS (US)

(21) Appl. No.: 16/040,313

(22) Filed: Jul. 19, 2018

Related U.S. Application Data
(60) Provisional application No. 62/557,603, filed on Sep. 12, 2017.

(51) Int. Cl. A47J 37/07

(52) U.S. Cl. CPC A47J 37/0713; A47J 2037/0777

(57) ABSTRACT

A firebox for a cooking grill having a modular design as well as methods of manufacturing and assembling the same is provided. In an embodiment, a cooking grill includes a firebox formed from multiple attached sections. The firebox includes a first firebox section that is shaped, sized, and adapted to form a first end of the firebox and a second firebox section that is shaped, sized, and adapted to form a second end of the firebox. The firebox may further include one or more intermediate firebox sections that are attachable between the first and second firebox sections in interposed fashion to form an assembled firebox. Each section of the firebox may have a mateable attachment structure that allows for modular assembly.

### CROSS-REFERENCE TO RELATED APPLICATIONS AND CLAIM OF PRIORITY

This Non-Provisional patent application claims priority benefit of U.S. Provisional Patent Application No. 62/557,603, filed Sep. 12, 2017, titled “Cast Aluminum Grill with Modular Firebox,” having Attorney Docket No. OOKI.280723, the entire contents of which is incorporated herein by reference.

### TECHNICAL FIELD

The field relates to cooking grills and fireboxes.

### BACKGROUND

Most gas and charcoal grills include steel fireboxes. Steel is strong, easy to form, and readily available. However, steel can rust and eventually break down. It is known that an aluminum firebox can last much longer and is often considered a premium option. Aluminum fireboxes, however, can be more costly to manufacture. While sheets of steel can be bent, formed, and then welded together, shaping aluminum is more challenging. Many aluminum fireboxes are cast, and although this provides a rigid, unitary firebox, it requires a separate mold for each sized grill that is produced. Molds can cost several hundred thousand dollars each. Therefore, manufacturers are often reluctant to make cast grills in multiple sizes due to the associated cost. This limits the options available to consumers.

### SUMMARY

This summary is intended to introduce a selection of concepts in a simplified form that are further described below in the detailed description section of this disclosure. This summary is not intended to identify key or essential features of the claimed subject matter, and it is not intended to be used as an aid in isolation for determining the scope of the claimed subject matter.

In brief, and at a high level, this disclosure describes cooking grills that incorporate fireboxes with a modular design, as well as methods of manufacturing and assembling the same. In one embodiment, a cooking grill is provided that includes a modular firebox. The firebox is assembled from multiple sections, including a first firebox section that is shaped and sized to form a first end of the firebox and a second firebox section that is shaped and sized to form a second end of the firebox. The firebox may further include one or more intermediate firebox sections. Each intermediate firebox section may be formed such that it can be attached between the first and second firebox sections and/or between other intermediate firebox sections in interposed fashion. The different sections of the firebox may each include mateable attachment structures that allow the sections to be attached together to form a desired modular configuration (e.g., a firebox having one, two, or three intermediate portions, or no intermediate portions). This modular adaptability allows for design flexibility without requiring individual molds for each different sized firebox that is made. This can lower the complexity and cost of manufacturing cooking grills of different sizes and shapes, among other benefits.

In one embodiment hereof, a modular firebox for a cooking grill is provided. The modular firebox includes a first firebox section that forms a first end of the firebox, a second firebox section that forms a second end of the firebox, and one or more intermediate firebox sections that are attachable between the first firebox section and the second firebox section. The first firebox section and the second firebox section are attachable directly to each other to form the assembled firebox and/or are attachable to each other via the one or more intermediate firebox sections to form the assembled firebox.

In another embodiment hereof, a method of assembling a modular firebox for a cooking grill is provided. The method comprises positioning a first firebox section having a first mateable structure at a first location and positioning a second firebox section having a second mateable structure at a second location. The first firebox section forms a first end of the assembled firebox and the second firebox section forms a second end of the assembled firebox. The method further comprises positioning one or more intermediate firebox sections between the first firebox section and the second firebox section. Each of the one or more intermediate firebox sections includes a third mateable structure that is attachable to the first mateable structure and a fourth mateable structure that is attachable to the second mateable structure. The method further comprises attaching, in interposed fashion, the one or more intermediate firebox sections between the first firebox section and the second firebox section to form the assembled firebox.

In another embodiment hereof, a method of manufacturing a modular firebox for a cooking grill is provided. The method comprises casting a first firebox section that is shaped to form a first end of the firebox, casting a second firebox section that is shaped to form a second end of the firebox, and casting one or more intermediate firebox sections that are attachable in interposed fashion between the first firebox section and the second firebox section to form the assembled firebox. The first firebox section and the second firebox section may be attachable directly to each other to form the assembled firebox and/or may be attachable to each other via the one or more intermediate firebox sections to form the assembled firebox.

The term “firebox section” as used herein is intended to encompass any structure that forms part of a firebox for a grill. A firebox section may be formed of one or multiple pieces, and may take on a variety of different shapes, sizes, and contours. A firebox section may also include various fixed or removable features.

### BRIEF DESCRIPTION OF THE DRAWINGS

The subject matter disclosed herein is described in detail with reference to the attached drawing figures, which are intended to illustrate non-limiting examples of the disclosed subject matter related to modular cooking grills and fireboxes, in which like numerals refer to like elements, wherein:

FIG. 1 is a top, front, right perspective view of a modular firebox looking downward into an interior thereof, in accordance with an embodiment of the disclosure;

FIG. 2 is a bottom, rear, left perspective view of the modular firebox of FIG. 1 looking upward at an underside thereof;

FIG. 3 is another top, front perspective view of the modular firebox of FIGS. 1-2 with an end section removed;

FIG. 4 is a right side perspective view of the modular firebox shown in FIG. 3 looking towards an interior of the firebox;

FIG. 5 is a perspective view of a firebox section that forms a left end of the modular firebox shown in FIGS. 1-2;

FIG. 6 is a perspective view of a firebox section that forms a right end of the modular firebox shown in FIGS. 1-2;

FIG. 7 is a front perspective view of a pair of front and rear intermediate firebox section sides that are attachable between the firebox sections shown in FIGS. 5-6;

FIG. 8 is a rear perspective view of the pair of intermediate firebox section sides shown in FIG. 7, shown from the opposite side;

FIG. 9 is a rear perspective view of the firebox shown in FIGS. 1-2;

FIG. 10 is a perspective view of a burner tube, igniter, and grate for a firebox, in accordance with embodiments of the disclosure;

FIG. 11 is a top-down perspective view of the modular firebox shown in FIGS. 1-2 looking into the interior thereof;

FIG. 12 is a perspective view of a grill that incorporates the modular firebox shown in FIGS. 1-2, in accordance with an embodiment of the disclosure;

FIG. 13 is a block diagram of a method for assembling a modular firebox, in accordance with an embodiment of the disclosure; and

FIG. 14 is a block diagram of a method for manufacturing a modular firebox, in accordance with an embodiment of the disclosure.

### DETAILED DESCRIPTION

The subject matter of the invention is described herein to meet statutory requirements. However, this description is not intended to limit the scope of the invention. Rather, the claimed subject matter may be embodied in other ways, to include different steps, combinations of steps, features, and/or combinations of features, similar to those described in this disclosure, and in conjunction with other present or future technologies. Moreover, although the terms “step” and/or “block” may be used herein to identify different elements of methods employed, the terms should not be interpreted as implying any particular order among or between various steps or blocks except when the order is explicitly described and required.

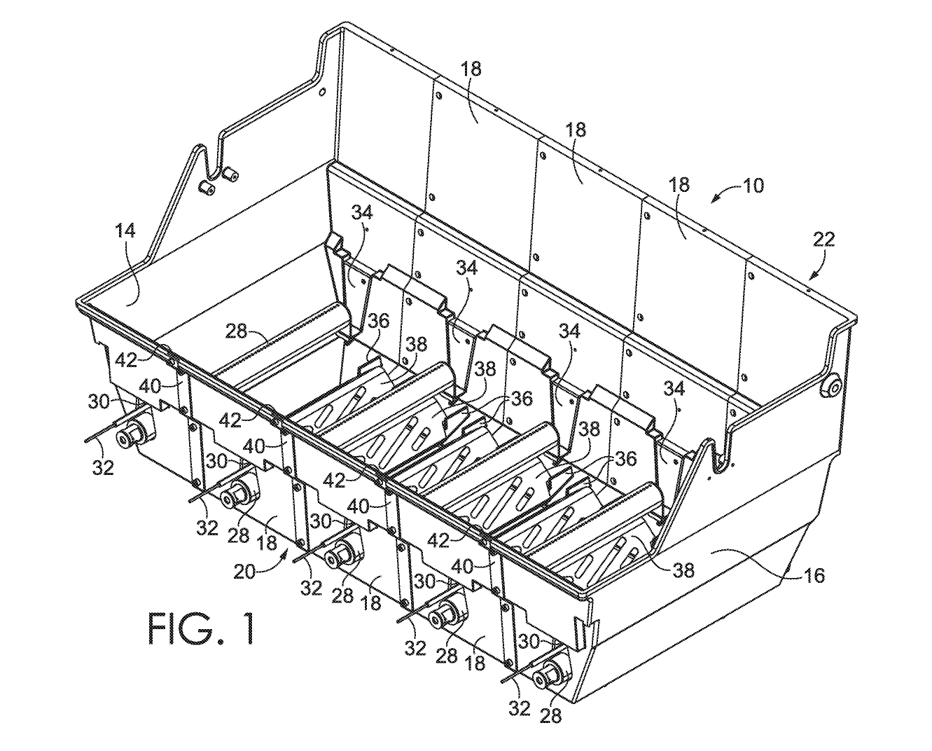

At a high level, the subject matter of this disclosure relates generally to modular cooking grills and fireboxes, as well as methods of manufacturing and assembling the same. In particular, in one disclosed embodiment, a modular firebox for a cooking grill that is formed from multiple sections is provided. In such an embodiment, one section is shaped and sized to form a first end of the firebox, and another section is shaped and sized to form an opposite, second end of the firebox. Further, one or more intermediate firebox sections are shaped, sized, and adapted to be attached between the first and second firebox sections to form a modular firebox that is adaptable into different sizes. The separate firebox sections of the referenced embodiment also include attachment structures that allow the firebox sections to be attached and secured together. Further, some firebox sections may include structures for supporting grill components, such as burner tubes, grates, igniters, grill covers, and/or other grill-related structures. Example embodiments of these grills and fireboxes, as well as methods of manufacturing and assembling the same, are discussed in further detail below with reference to FIGS. 1-14.

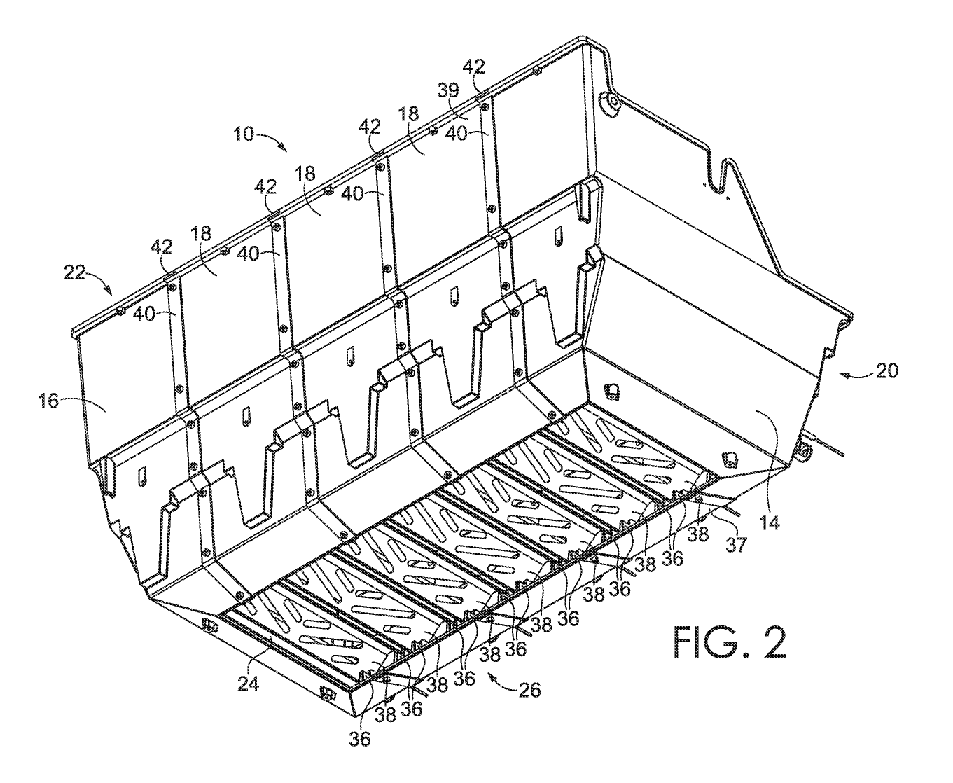

Referring now to FIG. 1, a perspective view of a modular firebox 10 for a cooking grill is provided, in accordance with an embodiment of the disclosure. The firebox 10 shown in FIG. 1 includes a firebox section 14 that is sized, shaped, and contoured to form a first end (e.g., a left end) of the firebox 10, and a firebox section 16 that is sized, shaped, and contoured to form a second end (e.g., a right end) of the firebox 10. The firebox 10 further includes a plurality of intermediate firebox sections 18 that are interposed, in modular fashion, between firebox section 14 and firebox section 16. Each intermediate firebox section 18, as discussed further below, may be formed of a single, unified piece that extends from a first side 20 (e.g., a front side) of the firebox 10 to an opposite second side 22 (e.g., a rear side) of the firebox 10, or may be formed from multiple separate pieces. For example, each intermediate firebox section 18 may actually be a pair of intermediate firebox section sides that are shaped, sized, and/or otherwise contoured to be attached along the respective first or second side 20, 22 of the firebox 10. This design allows for an opening 24 to be provided on an underside 26 of the firebox 10, as shown most clearly in FIG. 2. This opening 24 may allow for grates or other grill structures to be exposed at the underside 26 of the firebox 10, and further may support the cleaning of the firebox 10, or may allow for reduced weight and material usage, in addition to other advantages. It should be noted that in alternative embodiments, no opening may be provided on the underside 26 of the firebox 10.

FIG. 1 further shows, within the firebox 10, a plurality of burner tubes 28 that are used to provide a flame source within the firebox 10. Each burner tube 28 has an elongated shape and is supported by a corresponding firebox section 14, 16, or 18. In this regard, in the illustrated embodiment, each firebox section 14, 16, 18 includes an opening 30 located on the first side 20 of the firebox 10. Each opening 30 is sized and positioned to at least partially support an end of one of the burner tubes 28 that is positioned therein. Each opening 30 also provides a location for positioning an igniter 32 that is used to ignite gas emitted by the burner tube 28. Each firebox section 14, 16, 18 of the firebox 10 further includes an indentation 34 located on the second side 22 of the firebox 10 that is sized and positioned to support an opposite end of a burner tube 28. The openings 30 and the indentations 34 support the burner tubes 28, allowing them to extend across the firebox 10 between the first and second sides 20, 22.

The firebox sections 14, 16, 18, in the illustrated embodiment, further include support structures 36 that are adapted to support grates 38 positioned underneath the burner tubes 28 in the firebox 10. The support structures 36 comprise distally extending features that provide contact and support points for the grates 38. Alternatively, the support structures 36 may just be used to prevent lateral movement of the grates 38 and ends of the grates 38 are supported directly on the firebox sections 14, 16, 18. The grates 38 may assist in catching ash, drippings, or other debris that falls while the firebox 10 is in use for cooking purposes.

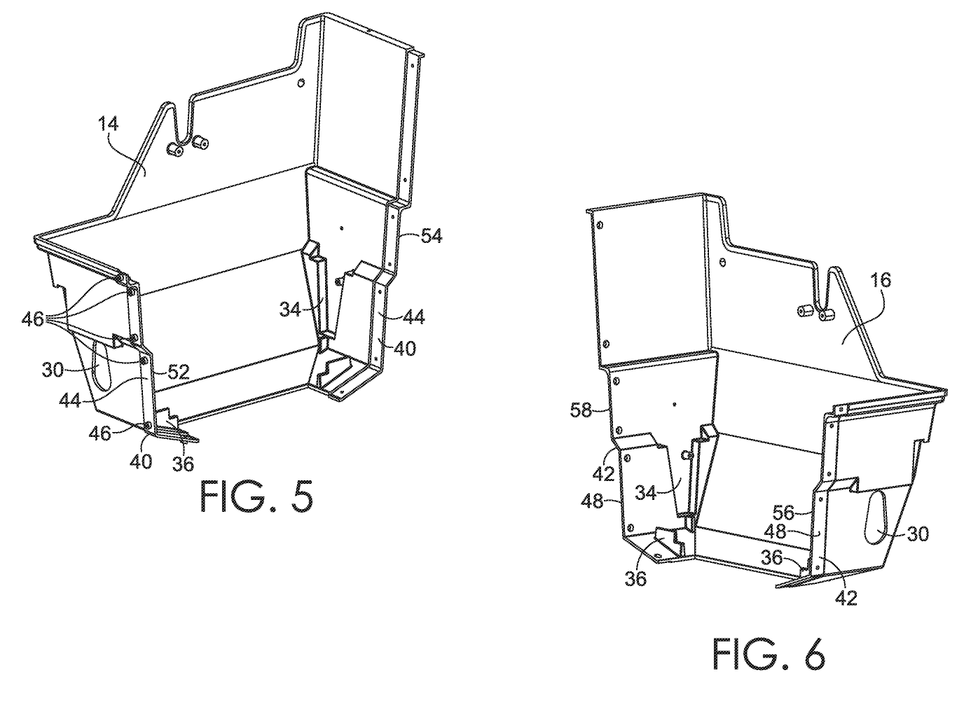

With continued reference to FIG. 1, each of the firebox sections 14, 16, 18 includes at least one mateable attachment structure 40, 42, shown most clearly in FIG. 1 on the first side 20 of the firebox 10 (these structures are also present on the second side 22 of the firebox 10, as shown in other figures). More specifically, as shown in greater detail in FIGS. 5, 6, and 7, each of the firebox sections 14, 16, 18 includes a mateable attachment structure 40 or 42 that is mateable and attachable with the other of the mateable attachment structures 40 or 42 that is located on an adjacent firebox section 14, 16, 18. In other words, a mateable attachment structure 40 located on one section of the firebox 10 is mateable and attachable with a mateable attachment structure 42 located on another adjacent section of the firebox 10. This allows the different firebox sections 14, 16, 18 of the firebox 10 to be secured together to form the assembled firebox 10.

The modular design of the firebox 10 shown in FIG. 1 enables the firebox sections 14, 16, 18 to be used to form fireboxes of different sizes (e.g., those having more or fewer burner tubes 28 than the firebox 10 shown in FIG. 1) without having to cast multiple unitary fireboxes using different molds or tooling. In other words, the modular nature of the firebox 10 allows for different sizes of fireboxes and cooking grills to be manufactured or adapted with reduced tooling cost and complexity. For example, a firebox with one, two, three, or more intermediate firebox sections 18, or no intermediate firebox sections 18, may be assembled using the components of the firebox 10 shown in FIG. 1.

Turning now to FIG. 2, a perspective view of the modular firebox 10 shown in FIG. 1, but looking upward at the underside 26 thereof, is provided, in accordance with an embodiment of the disclosure. FIG. 2 further depicts how the underside 26 of the firebox 10 includes the opening 24 across which the grates 38 extend when in position in the firebox 10. FIG. 2 further shows that the second side 22 of the firebox 10 includes similar mateable attachment structures 40, 42 as the first side 20 with respect to the different firebox sections 14, 16, 18.

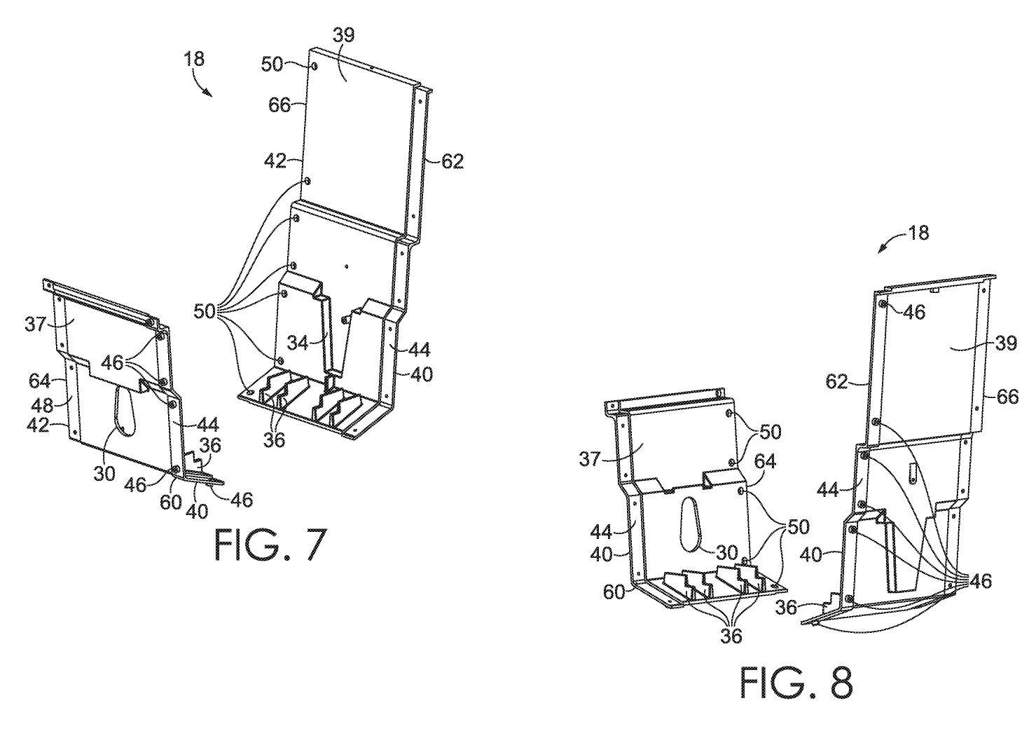

In the illustrated embodiment, each intermediate firebox section 18 of the example firebox 10 shown in FIGS. 1-2 is actually formed from a pair of opposite firebox section sides 37, 39, which are shown in isolation in FIGS. 7-8. Further, the mateable attachment structures 40 and 42 referenced above are located on opposite edges of each side 37, 39, allowing the respective sides 37, 39 to be joined to adjacent intermediate firebox sections 18, as shown in FIG. 2. This allows any number of intermediate firebox sections 18 to be interposed between the firebox sections 14, 16 to produce fireboxes of different sizes. Each firebox section 14, 16 also includes one of the mateable attachment structures 40 or 42, as shown in FIGS. 7-8, which allows it to be attached to one of the intermediate firebox sections 18 or to the opposite firebox section 14 or 16.

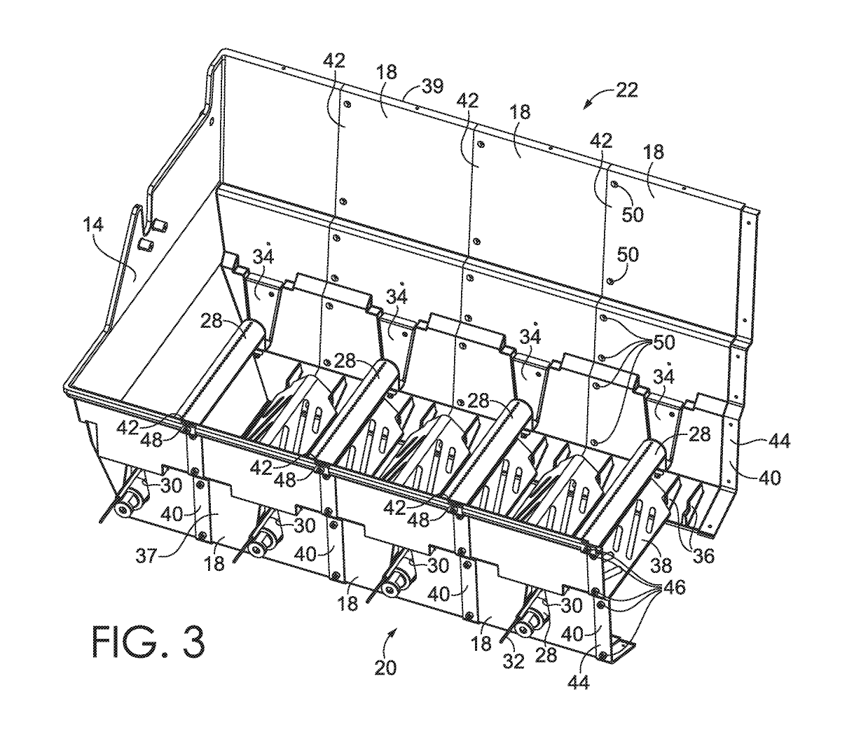

Referring now to FIG. 3, a perspective view of the modular firebox 10 shown in FIGS. 1-2 is provided, but looking into an interior of the firebox 10 and with the end section 16 removed for clarity. FIG. 3 depicts how the mateable attachment structure 40 is incorporated on the firebox section 14 and how both of the mateable attachment structures 40, 42 are also incorporated on opposite edges of each side 37, 39 of each intermediate firebox section 18. Further, although not shown in FIG. 3, the removed firebox section 16 also incorporates the mateable attachment structure 42, as shown in FIG. 6.

The mateable attachment structure 40 includes a connection flange 44 that has a plurality of securing structures 46 spaced thereon. For the firebox 10 shown in FIG. 3, the securing structures 46 are fastener bosses that are adapted to receive and engage an elongated fastener, such as a threaded screw. The mateable attachment structure 42 includes a connection flange 48 that is mateable with the connection flange 44 of the mateable attachment structure 40. The mateable attachment structure 42 further includes a plurality of securing structures 50, which in the example firebox 10 shown in FIG. 3, are a plurality of spaced fastener apertures that are countersunk. Accordingly, as shown in FIG. 3, the securing structures 50 of one mateable attachment structure 42 are alignable with the securing structures 46 of an adjacent mateable attachment structure 40 when the two are brought together. This alignment allows the elongated fasteners referenced herein to be threaded into and engaged with the securing structures 50, 46, thereby securing the adjoined mateable attachment structures 40, 42 together and also, by association, securing the adjoined firebox sections (e.g., 14 and 18) together.

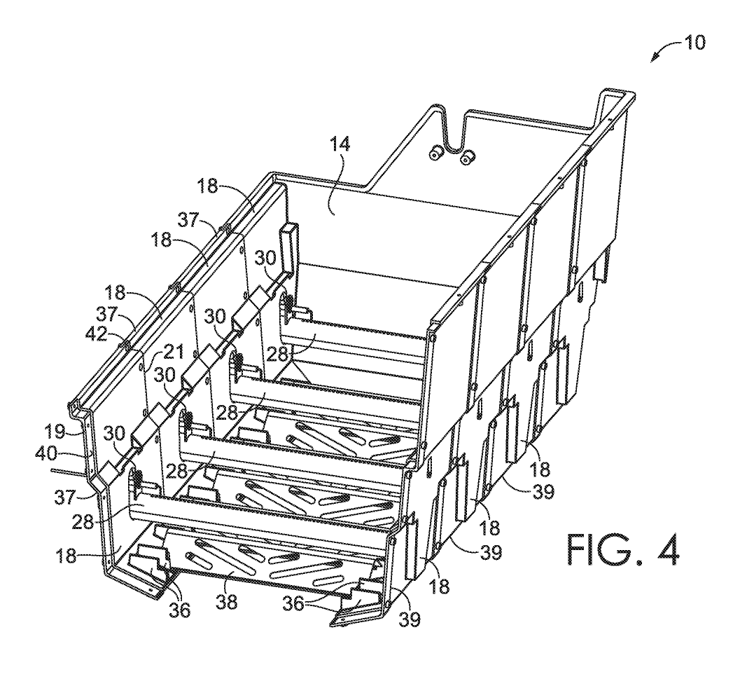

Referring now to FIG. 4, a side perspective view of the modular firebox 10 shown in FIG. 3 looking towards an interior of the firebox 10 with the firebox section 16 removed is provided, in accordance with an embodiment of the disclosure. FIG. 4 depicts how the burner tubes 28 extend across the firebox sections 14, 18 and are supported by the openings 30 and the indentations 34 (obscured in FIG. 4 but shown in FIG. 1) of the respective firebox sections 14, 18. FIG. 4 also depicts how the grates 38 are supported by the support structures 36 extending from the firebox sections 14, 18. Further, the pair of firebox section sides 37, 39 of each intermediate firebox section 18 are shown. The firebox section sides 37, 39 form parts of the first and second sides 20, 22 of the firebox 10 when the firebox 10 is assembled. Each firebox section side 37, 39 of each intermediate firebox section 18 includes one mateable attachment structure 40 located on one edge (e.g., edge 19) and one mateable attachment structure 42 located on an opposite edge (e.g., edge 21), which allows the respective sides 37, 79 to be attached together along each side 20, 22 of the firebox 10.

Referring now to FIGS. 5-6, perspective views of the firebox sections 14 and 16 that form the ends of the firebox 10 shown in FIG. 1 are provided. FIG. 5 depicts in isolation the firebox section 14 that forms the first or left end of the firebox 10 shown in FIG. 1. FIG. 5 therefore shows the opening 30, the indentation 34, the supports 36, and the various corners, surfaces, and contours of the firebox section 14. The firebox section 14 also includes the mateable attachment structure 40 described herein extending along one edge 52 of the firebox section 14 and also separately along another edge 54 of the firebox section 14.

Each mateable attachment structure 40 located on the firebox section 14 is adapted to engage with and be attached to a mateable attachment structure 42 located on an intermediate firebox section 18 (e.g., on the opposite sides 37, 39 thereof). Each mateable attachment structure 40 is also adapted to engage with and be attached to a mateable attachment structure 42 located on the firebox section 16, if no intermediate firebox sections 18 are included and the firebox 10 is formed only from the attaching firebox sections 14, 16 directly together.

FIG. 6 depicts in isolation the firebox section 16 that forms the second or right end of the firebox 10 shown in FIG. 1. The firebox section 16 includes similar features as the firebox section 14 shown in FIG. 5, except that it includes the mateable attachment structure 42 and the connection flange 48 thereof extending along its edges 56, 58. The mateable attachment structure 42 located on the firebox section 16 is therefore mateable with and attachable to the mateable attachment structure 40 as it is located on the other firebox section 14 or on one of the intermediate firebox sections 18.

Referring to FIGS. 7-8, front and rear perspective views of opposite sides 37, 39 of an intermediate firebox section 18 that can be attached between the firebox sections 14, 16 of the firebox 10 shown in FIGS. 1-2 are provided, in accordance with embodiments hereof. FIGS. 7-8 show how one side 37 of the intermediate firebox section 18 forms part of the first side 20 of the firebox 10 shown in FIGS. 1-2, and the other side 39 of the intermediate firebox section 18 forms part of the second side 22 of the firebox 10 shown in FIGS. 1-2. In other words, the opposite sides 37, 39 shown in FIGS. 7-8 collectively define an intermediate firebox section 18 that can be attached between firebox section 14 and firebox section 16, and/or between other intermediate firebox sections 18 of the firebox 10 shown in FIGS. 1-2. In the embodiments shown in FIGS. 7 and 8, the side 37 includes the opening 30 and the side 39 includes the indentation 34 which are used to support a burner tube 28 in the firebox 10, as shown in FIGS. 1-2.

FIGS. 7-8 also depict how the mateable attachment structure 40 extends along the edges 60, 62 of each side 37, 39 of the intermediate firebox section 18 and how the corresponding mateable attachment structure 42 extends along the edges 64, 66 of each side 37, 39 of the intermediate firebox section 18. The edges 64, 66 of the sides 37, 39 are therefore adapted to engage one of the mateable attachment structures 40, such as one located on firebox section 14 shown in FIGS. 1-2 or located on another intermediate firebox section 18, and the edges 60, 62 of the sides 37, 39 are adapted to engage one of the mateable attachment structures 42, such as one located on firebox section 16 shown in FIGS. 1-2 or on another intermediate firebox section 18. It should be noted that the sides 37, 39 that form the intermediate firebox section 18 depicted in FIGS. 7-8 illustrate one example configuration, and other configurations, including those with different sizes, shapes, and/or contours, are contemplated herein.

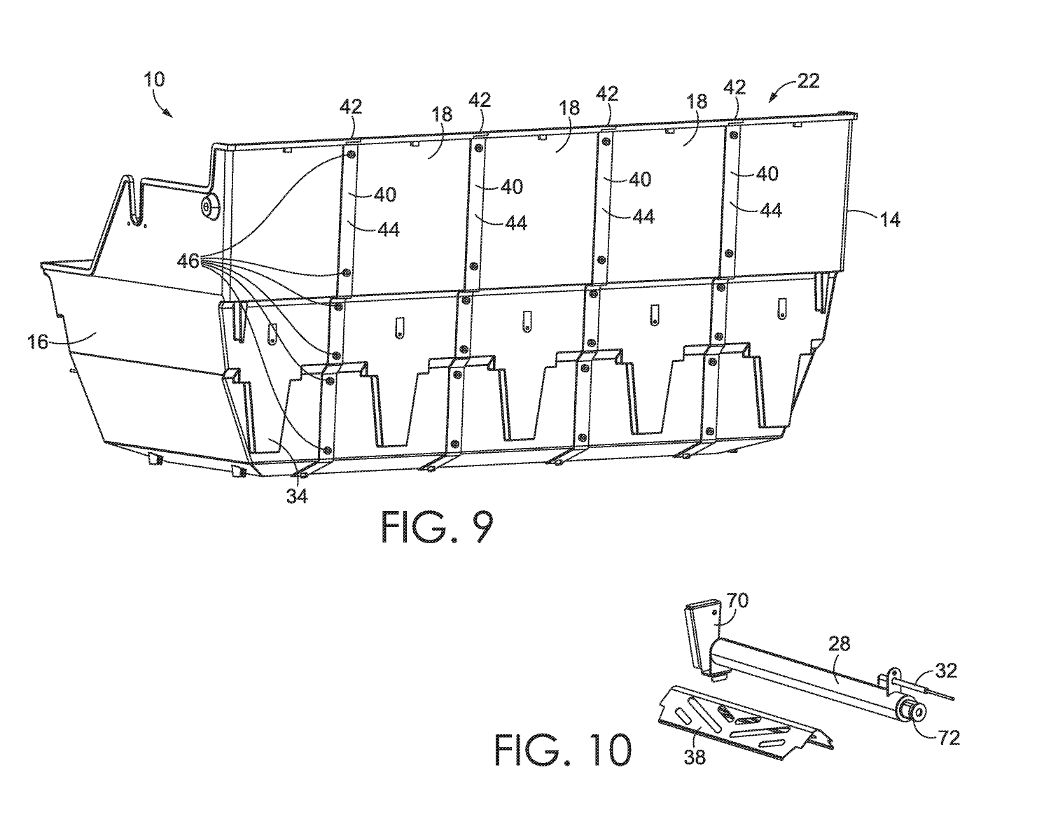

Referring to FIG. 9, a rear perspective view of the firebox 10 shown in FIGS. 1-2 is provided. FIG. 9 shows the firebox 10 assembled with the firebox section 14 forming one end, the firebox section 16 forming another end, and three intermediate firebox sections 18 are interposed between firebox section 14 and firebox section 16. FIG. 9 primarily depicts a rear of the second side 22 of the firebox 10, and depicts how the mateable attachment structures 40 and the mateable attachment structures 42 of various adjoined firebox sections 14, 16, 18 of the firebox 10 overlap and are attached. Accordingly, for each pair of overlapping mateable attachment structures 40, 42, the plurality of securing structures 46 (e.g., fastener bosses) located on the connection flange 44 of the mateable attachment structure 40 are at least partially aligned with the plurality of securing structures 50 (e.g., apertures) located on the connection flange 48 of the mateable attachment structure 42. In FIG. 9, the securing structures 50 are obscured, but they are shown in FIG. 7. This overlapping configuration of the connection flanges 44, 48 and alignment of the securing structures 46, 50 thereon allows for adjacent sections of the firebox 10 to be secured to each other, such as, for example, by threading a plurality of elongated fasteners respectively through the securing structures 50 and then securing them to the respectively aligned securing structures 46, thereby securing connection flanges 44 and 48 together.

Referring to FIG. 10, perspective views of a burner tube 28, igniter 32, and grate 38 for a modular firebox, such as the firebox 10 depicted in FIGS. 1-2, are provided, in accordance with embodiments of the disclosure. The burner tube 28 includes a first end support 70 that is sized to rest within an indentation, such as the indentation 34 shown in FIG. 1, to support the burner tube 28 within a firebox. The burner tube 28 further includes the igniter 32 for igniting a fuel source emitted from the burner tube 28. Additionally, the burner tube 28 includes a fuel inlet 72 to which a gas valve (not depicted in FIG. 10) may be coupled for selectively providing a flow of fuel to the burner tube 28. The inlet 72 also represents a portion of the burner tube 28 that may be supported by the opening 30 in the firebox 10 of FIG. 1. The grate 38 may be formed from metal or another material, and is angled to facilitate the collection/dispersion of debris that falls from the grill.

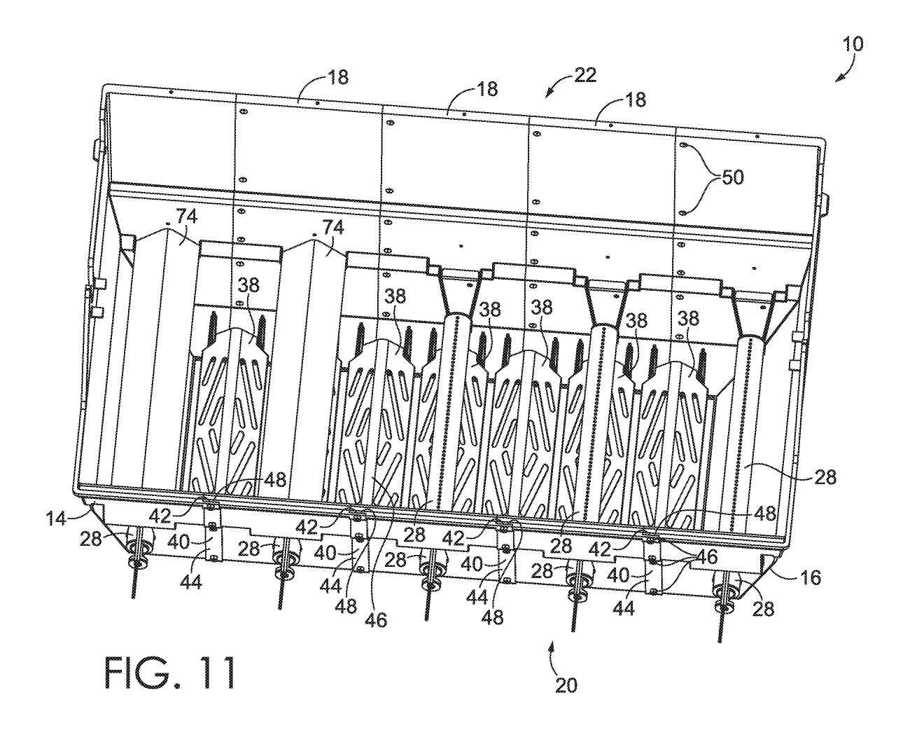

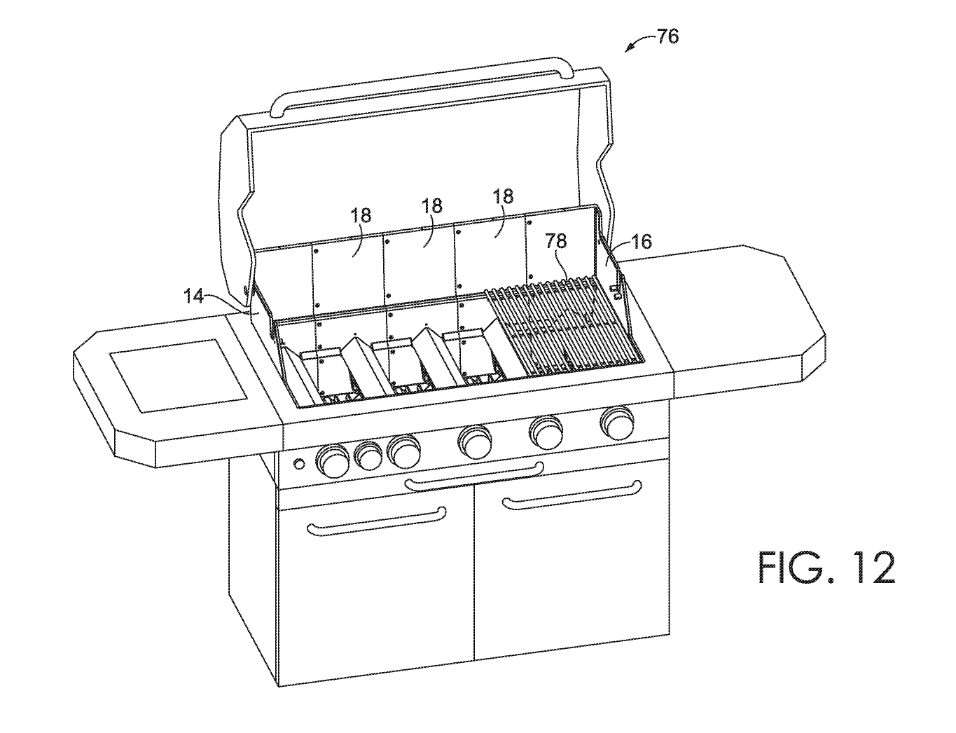

Referring to FIG. 11, a top-down perspective view of the firebox 10 shown in FIGS. 1-2 is provided, in accordance with an embodiment of the disclosure. FIG. 11 depicts how the burner tubes 28 extend across the firebox section 14 (though partially obscured), the intermediate firebox sections 18, and the firebox section 16 of the firebox 10, with the grates 38 positioned underneath the burner tubes 28 to catch debris and ash. FIG. 11 further depicts how the flanges 44, 48 of the mateable attachment structures 40, 42 overlap, allowing the adjacent firebox sections 14, 16, 18 to be attached to each other (e.g., using elongated fasteners, such as threaded screws, that couple the mateable attachment structures 40, 42 together). FIG. 11 further depicts flame tamers 74 that are positioned in the firebox 10 so that they extend over the burner tubes 28 to help control a flame emitted by the burner tubes 28 and to prevent drippings (e.g., grease) from cooking meats from falling onto the burner tubes 28.

FIG. 12 is a perspective view of a grill 76 that has the modular firebox 10 of FIGS. 1-11 incorporated therein, in accordance with an embodiment of the present disclosure. FIG. 12 depicts how, once the modular firebox 10 is assembled from firebox section 14, firebox section 16, and any desired intermediate firebox sections 18, which in the case of the grill 76 is three intermediate firebox sections 18 providing five total burner tubes in the firebox 10, the firebox 10 can be incorporated into the grill 76 for use. The firebox 10 can further be covered with a grill surface 78 as shown in FIG. 12. A gas manifold (not shown) couples the inlets 72 of the burner tubes 28 together and delivers gas to the gas tubes 28 from a gas source (e.g., a propane tank stored in a cabinet of the grill 76). The gas manifold is hidden behind a housing of the grill 76. As illustrated, each gas tube 28 has a corresponding gas knob that a grill operator may use to adjust the supply of gas to each gas tube 28. As noted herein, by using a modular firebox, different sized fireboxes and grills can be assembled with reduced tooling and manufacturing complexity and cost.

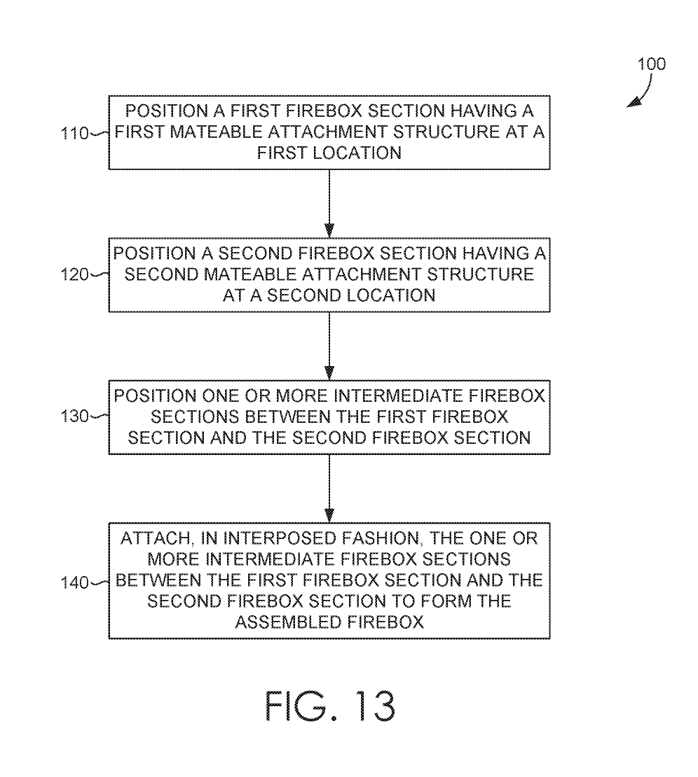

Referring to FIG. 13, a block diagram of an example process 100 for assembling a modular firebox for a cooking grill is provided, in accordance with an embodiment of the present disclosure. In block 110, a first firebox section, such as the firebox section 14 shown in FIG. 5, having a first mateable attachment structure, such as the mateable attachment structure 40 shown in FIG. 5, is positioned at a first location. In block 120, a second firebox section, such as the firebox section 16 shown in FIG. 6, having a second mateable attachment structure, such as the mateable attachment structure 42 shown in FIG. 6, is positioned at a second location. The first firebox section may form a first end of the firebox once assembled and the second firebox section may form a second end of the firebox once assembled.

In block 130, one or more intermediate firebox sections, such as the intermediate firebox sections 18 shown in FIG. 1, are positioned between the first firebox section and the second firebox section. Each of the one or more intermediate firebox sections may include a third mateable attachment structure, such as the mateable attachment structure 42 shown in FIGS. 7 and 8, that is attachable to the first mateable attachment structure, and a fourth mateable attachment structure, such as the mateable attachment structure 40 shown in FIGS. 7 and 8, that is attachable to the second mateable attachment structure. In this sense, each section may include a mateable attachment structure that mates and attaches with a corresponding mateable attachment structure on another section. In block 140, the one or more intermediate firebox sections are attached, in interposed fashion, for example as shown in FIG. 1, between the first firebox section and the second firebox section to form the assembled firebox.

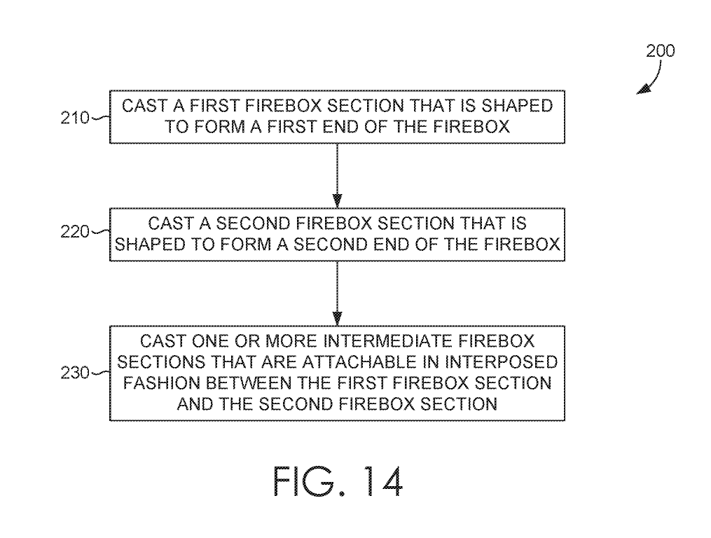

Referring to FIG. 14, a block diagram of an example process 200 for manufacturing a modular firebox, such as the firebox 10 shown in FIG. 1, for a cooking grill is provided, in accordance with an embodiment of the disclosure. In block 210, a first firebox section, such as the firebox section 14 shown in FIG. 5, is cast so that it is shaped to form a first end of the firebox. In block 220, a second firebox section, such as the firebox section 16 shown in FIG. 6, is cast so that it is shaped to form a second end of the firebox. In block 230, one or more intermediate firebox sections, such as the intermediate firebox sections 18 shown in FIG. 1, are cast that are attachable in interposed fashion between the first firebox section and the second firebox section. In some embodiments, mateable attachment structures positioned on the different sections may be configured such that the first firebox section and the second firebox section are attachable directly to each other to form the assembled firebox or are attachable to each other via the one or more intermediate firebox sections to form the assembled firebox.

The subject matter of this disclosure has been described in relation to particular embodiments, which are intended in all respects to be illustrative rather than restrictive. Alternative embodiments will become apparent to those of ordinary skill in the art to which the present subject matter pertains without departing from the scope hereof. Different combinations of elements, as well as use of elements not shown, are also possible and contemplated.

What is claimed is:

1. A modular firebox for a cooking grill, comprising:
a first firebox section that forms a first end of the firebox;
a second firebox section that forms a second end of the firebox; and
one or more intermediate firebox sections that are attachable between the first firebox section and the second firebox section,
wherein the first firebox section and the second firebox section are attachable directly to each other to form the assembled firebox or are attachable to each other via the one or more intermediate firebox sections to form the assembled firebox.

2. The modular firebox of claim 1, wherein the first firebox section, the second firebox section, and the one or more intermediate firebox sections are each formed at least partially from cast aluminum.

3. The modular firebox of claim 1, wherein each of the intermediate firebox sections comprises a pair of opposing intermediate firebox section sides, each pair of intermediate firebox section sides forming at least a portion of side walls of the firebox when coupled between the first firebox section and the second firebox section.

4. The modular firebox of claim 3, further comprising one or more burner tubes, each of the one or more burner tubes comprising a gas valve, and each of the one or more burner tubes configured to be coupled between a respective pair of intermediate firebox section sides in the firebox.

5. The modular firebox of claim 4, wherein each pair of intermediate firebox section sides includes an opening on one of the pair and an indentation on the other of the pair that are useable for supporting one of the burner tubes in the firebox.

6. The modular firebox of claim 1, further comprising one or more igniters that are respectively attachable to the one or more intermediate firebox sections.

7. The modular firebox of claim 1, wherein the one or more intermediate firebox sections each include a support structure useable for supporting a grate in the firebox.

8. The modular firebox of claim 1, wherein the first firebox section comprises a first mateable attachment structure and the second firebox section comprises a second mateable attachment structure that is attachable to the first mateable attachment structure, and wherein each of the one or more intermediate firebox sections includes a respective third mateable attachment structure that is attachable to the first mateable attachment structure on the first firebox section and a fourth mateable attachment structure that is attachable to the second mateable attachment structure on the second firebox section.

9. The modular firebox of claim 8, wherein the first mateable attachment structure comprises a first connection flange located at an edge of the first firebox section, and wherein the second mateable attachment structure comprises a second connection flange located at an edge of the second firebox section, the first and second connection flanges being alignable and mateable with each other.

10. The modular firebox of claim 9, wherein the first connection flange comprises a first plurality of mateable securing structures, and wherein the second connection flange comprises a second plurality of mateable securing structures that are respectively alignable and attachable with the first plurality of mateable securing structures.

11. The modular firebox of claim 10, wherein the third mateable attachment structure comprises at least one third connection flange having a third plurality of mateable securing structures that are respectively alignable and attachable with the first plurality of mateable securing structures, and wherein the fourth mateable attachment structure comprises at least a fourth connection flange having a fourth plurality of mateable securing structures that are respectively alignable and attachable with the second plurality of mateable securing structures.

12. The modular firebox of claim 10, wherein the first plurality of mateable securing structures comprises a plurality of fastener bosses extending from the first connection flange, and wherein the second plurality of mateable securing structures comprises a plurality of apertures sized to respectively receive elongated fasteners that can be secured to the fastener bosses.

13. A method of assembling a modular firebox for a cooking grill, the method comprising:
positioning a first firebox section having a first mateable attachment structure at a first location;
positioning a second firebox section having a second mateable attachment structure at a second location, wherein the first firebox section forms a first end of the assembled firebox and the second firebox section forms a second end of the assembled firebox; and
positioning one or more intermediate firebox sections between the first firebox section and the second firebox section, wherein each of the one or more intermediate firebox sections includes a third mateable attachment structure that is attachable to the first mateable attachment structure and a fourth mateable attachment structure that is attachable to the second mateable attachment structure; and
attaching, in interposed fashion, the one or more intermediate firebox sections between the first firebox section and the second firebox section to form the assembled firebox.

14. The method of claim 13, wherein the first firebox section, the second firebox section, and the one or more intermediate firebox sections are each formed at least partially from cast aluminum.

15. The method of claim 13, further comprising:
aligning a first plurality of mateable securing structures located on the first mateable attachment structure with a second plurality of mateable securing structures located on the third mateable attachment structure; and
threading an elongated fastener through each of the respectively aligned first and third mateable securing structures and securing the respective elongated fastener therein to attach the first firebox section to one of the one or more intermediate firebox sections.

16. A method of manufacturing a modular firebox for a cooking grill, the method comprising:
casting a first firebox section that is shaped to form a first end of the firebox;
casting a second firebox section that is shaped to form a second end of the firebox; and
casting one or more intermediate firebox sections that are attachable in interposed fashion between the first firebox section and the second firebox section,
wherein the first firebox section and the second firebox section are attachable directly to each other to form the assembled firebox or are attachable to each other via the one or more intermediate firebox sections to form the assembled firebox.

17. The method of claim 16, wherein the first firebox section, the second firebox section, and the one or more intermediate firebox sections are cast from aluminum.

18. The method of claim 16, wherein the first firebox section and the second firebox section are cast to include a first connection flange and a second connection flange, respectively, the first connection flange including a first plurality of mateable securing structures spaced along the first connection flange and the second connection flange including a second plurality of mateable securing structures spaced along the second connection flange, and wherein the first and second pluralities of mateable securing structures are respectively alignable and attachable using a plurality of elongated fasteners.

19. The method of claim 18, wherein each of the one or more intermediate firebox sections comprises a pair of opposing intermediate firebox section sides, each pair of opposing intermediate firebox section sides having a third plurality of mateable securing structures that are respectively alignable and attachable with the first plurality of mateable securing structures and a fourth plurality of mateable securing structures that are respectively alignable and attachable with the second plurality of mateable securing structures.

20. The method of claim 16, wherein each of the one or more intermediate firebox sections includes a respective support structure adapted to support a grate.
